(19) United States
(12) Patent Application Publication
(10) Pub. No.: US 2008/0144670 A1
(43) Pub. Date: Jun. 19, 2008

(54) Data Processing System and a Method For Synchronizing Data Traffic

(75) Inventors: Kees Gerard Willem Goossens, Eindhoven (NL); Andrei Radulescu, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/720,207

(22) PCT Filed: Nov. 29, 2005
(86) PCT No.: PCT/IB2005/053954

§ 371 Date: May 25, 2007

(30) Foreign Application Priority Data
Dec. 1, 2004 (EP) 04106213.4

(51) Int. Cl. H04J 3/06

(52) U.S. Cl. 370/503

(57) ABSTRACT

The invention relates to a data processing system and a method for synchronizing data traffic. The data processing system according to the invention comprises a conversion unit, which conversion unit is arranged to convert a first flow control scheme applied in a first sub-network into a second flow control scheme applied in a second sub-network. The conversion unit may cooperate with or be integrated with another component, for example a component which performs conversion of operating frequency between sub-networks (clock-domain crossing). For the correct functioning of flow control it is necessary that separate flow control schemes are used for respectively the first sub-network and the second sub-network. The conversion unit performs a conversion between these schemes. For example, if the flow control schemes are credit-based the conversion unit computes the correct amount of credits for the first flow control scheme, based on the amount of credits available in the second flow control scheme. If necessary, credit conversion is performed. The latter is necessary when the flit sizes are different in the first and second sub-network, for example. The conversion unit translates the credits from the second sub-network (which credits represent a certain amount of data elements) into credits for the first sub-network. The number of credits may be different in respectively the first and second sub-network, for the same amount of data elements.

The invention relates to a data processing system on at least one integrated circuit, the data processing system comprising at least two modules and a network arranged to transmit data between the modules, the data processing system being arranged to apply a flow control scheme for synchronizing data traffic between the modules, wherein the network comprises a first sub-network and a second sub-network, the first sub-network and the second sub-network having different operating conditions.

The invention also relates to a method for synchronizing data traffic in a data processing system on at least one integrated circuit, the data processing system comprising at least two modules and a network which transmits data between the modules, wherein the data processing system applies a flow control scheme for synchronizing data traffic between the modules, wherein the network comprises a first sub-network and a second sub-network, the first sub-network and the second sub-network having different operating conditions

Networks-on-Chip (NoC's) have been proposed and widely accepted as an adequate solution for the problems relating to the interconnection of modules on highly complex chips. Compared to conventional interconnect structures such as single busses or hierarchies of busses, the network concept offers a number of important advantages. For example, (i) networks are able to structure and manage wires in deep sub-micron technologies satisfactorily, (ii) they allow good wire utilization through sharing, (iii) they scale better than busses, (iv) they can be energy-efficient and reliable, and (v) they decouple computation from communication through well-defined interfaces, which enables that the modules and the interconnect structure can be designed in isolation and integrated relatively easily.

A Network-on-Chip typically comprises a plurality of routers, which form the nodes of the network and which are arranged to transport and route the data through the network. Furthermore, the network is usually equipped with so-called network interfaces, which implement the interface between the modules connected to the network and the network itself. The modules are usually categorized into master modules and slave modules. The master modules send request messages to the slave modules, for example a request message comprising a write command accompanied by data which should be written in a memory (slave) module. The slave module may send back a response message including an acknowledgement of the receipt of the request message, or an indication of the success of the write operation requested by the master module. The request-response mechanism is often referred to as the transaction model. The combination of a request and a corresponding response is often referred to as a transaction.

Networks-on-Chip constitute a rapidly evolving area of research and development. In recent years many publications have been made, for example about network topologies or the design of components such as network interfaces, routers and switches. An important recent development is the concept of multi-chip networks. Multi-chip networks are divided into sub-networks which are dedicated to the communication between modules forming part of a sub-system and performing specific functions in a larger data processing system. The sub-networks reside on different integrated circuits (dies, boards or chips). Alternatively, sub-networks may reside on a single chip. In the latter case they may have different power or voltage domains.

In the context of the present invention U.S. Pat. No. 6,018,782 is particularly relevant. U.S. Pat. No. 6,018,782 discloses a single-chip integrated circuit which comprises a plurality of modules interconnected in an on-chip network. The modules are processors or memory devices or hybrids. An inter-module link provides an electrical path for data communication among the modules. The modules are connected to the inter-module link by inter-module ports, with at least one inter-module port coupled between an associated module and the inter-module link. The inter-module link electrically couples the inter-module ports and provides a communications pathway between the modules. The on-chip network may also include an inter-module network switch for joining circuits of the inter-module link and routing data packets from one inter-module links to another or an inter-chip network bridge to join two single chip integrated circuits into a single communications network and route data packets from modules on one computer chip to modules on another computer chip.

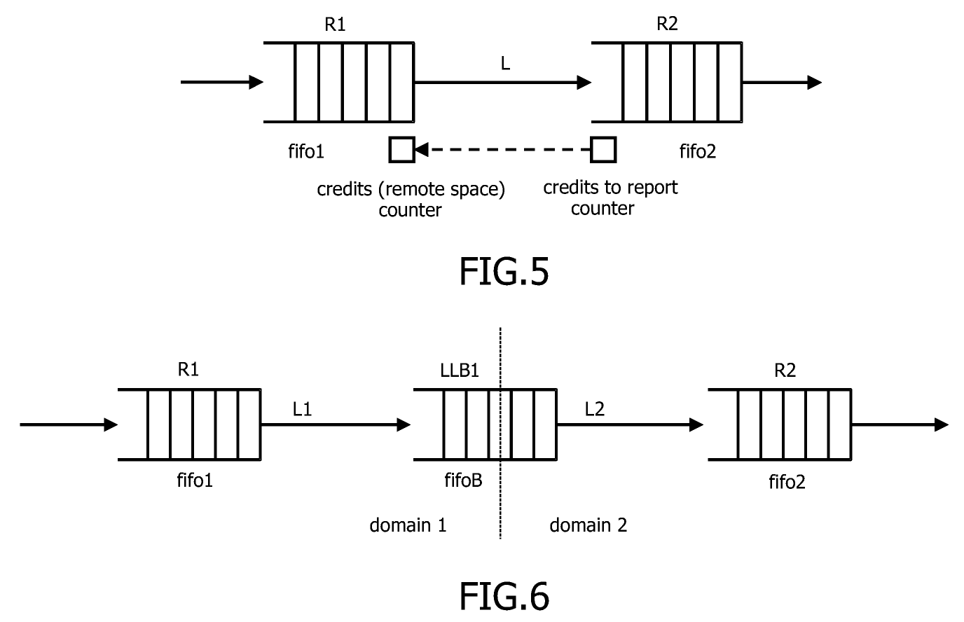

The inter-chip network bridge is capable of joining two computer chips to extend the on-chip network through a number of connectors, as can be seen in FIGS. 2 and 5 of U.S. Pat. No. 6,018,782. The inter-chip network bridge preferably includes one or more output buffers which operate to accept outgoing data destined for an address on a second computer chip, and one or more input buffers operable to receive incoming data destined for an associated address on the associated computer chip. The inter-chip network bridge accepts data to be transferred to the second computer chip into an output buffer when space in the output buffer is available. The data in the output buffer is transferred to a corresponding inter-chip network bridge on the second computer chip through the connectors, if the latter inter-chip network bridge signals availability to accept additional data.

It is apparent from the description of U.S. Pat. No. 6,018,782 that the network bridge only applies to communication between networks residing on different integrated circuits, and that it only comprises buffer means for temporarily storing data which should be transmitted from one network to another. There is no mechanism for synchronization of data transfer from one network to another. The facilities offered by the network bridge are very limited in the sense that it only offers a possibility to couple the network to another chip and thereby extend the network. It further provides relatively simple buffer means to queue data when a corresponding network bridge (comprised in the network on the other computer chip) indicates that it cannot accept additional data. Hence, a major disadvantage of this network bridge is that it cannot adequately synchronize the data traffic from one network to another.

It is also apparent that two components are needed, in particular a network bridge on a first computer chip and a cooperating network bridge on a second computer bridge, the combination of which negatively affects the performance of the network as a whole due to an increased latency. The negative effect on the performance is another disadvantage of the known network bridge.

Another relevant document is the article “Implementation of interface router IP for Proteo Network-on-Chip”, by Mikko Alho and Jari Nurmi, Institute of Digital Computer Systems, Tampere University of Technology, Finland. In this article an interface router IP for the Proteo NoC (developed at the Tampere University of Technology) is introduced and implemented. Besides the implementation of this interface router IP, the concept of multiple sub-networks is briefly illustrated, as well as the use of bridge components to interconnect the sub-networks into a larger network. However, a specification of these bridge components is absent. The above-mentioned lack of data traffic synchronization is not dealt with, nor mentioned as a technical problem caused by the possibly different characteristics of the various sub-networks.

It is an object of the invention to provide a means and a method for interconnecting sub-networks of the kind set forth, which means and method are able to adequately synchronize the data traffic between the sub-networks. This object is achieved by the data processing system as claimed in claim 1 and by the method as claimed in claim 7.

The data processing system according to the invention comprises a conversion unit, which conversion unit is arranged to convert a first flow control scheme applied in a first sub-network into a second flow control scheme applied in a second sub-network. The conversion unit may cooperate with or be integrated with another component, for example a component which performs conversion of operating frequency between sub-networks (clock-domain crossing). For the correct functioning of flow control it is necessary that separate flow control schemes are used for respectively the first sub-network and the second sub-network. The conversion unit performs a conversion between these schemes. For example, if the flow control schemes are credit-based the conversion unit computes the correct amount of credits for the first flow control scheme, based on the amount of credits available in the second flow control scheme. If necessary, credit conversion is performed. The latter is necessary when the flit sizes are different in the first and second sub-network, for example. The conversion unit translates the credits from the second sub-network (which credits represent a certain amount of data elements) into credits for the first sub-network. The number of credits may be different in respectively the first and second sub-network, for the same amount of data elements.

In an aspect of the invention, which is defined in claim 2, the data processing system deploys a flow control scheme for synchronizing data traffic between the modules, wherein the flow control scheme is based on credits stored in a first module, which credits represent the amount of data which can be received by a second module. This is often referred to as a credit-based flow control scheme.

In another aspect of the invention, which is defined in claim 3, the first sub-network comprises a first router and the second sub-network comprises a second router, an output of the first router being coupled to an input of the conversion unit, and an output of the conversion unit being coupled to an input of the second router, wherein the first router comprises a first buffer unit, and wherein the second router comprises a second buffer unit, wherein the conversion unit is arranged to receive data from the first buffer unit, and wherein the conversion unit is further arranged to store data for transmission to the second buffer unit, the conversion unit comprising an intermediate buffer unit for storing the data, characterized in that the communication between the first buffer unit and the intermediate buffer unit is controlled by the first flow control scheme, and in that the communication between the intermediate buffer unit and the second buffer unit is controlled by the second flow control scheme. The separate flow control schemes control separate pairs of buffers and the conversion unit converts between the flow control schemes.

In a further aspect of the invention, which is claimed in claim 4, the first sub-network and the second sub-network use flow control units having different sizes, and wherein the conversion unit is arranged to convert credits used by the second flow control scheme into credits used by the first flow control scheme. This is referred to as credit conversion; the credits used in the second flow control scheme are translated into credits for the first flow control scheme.

In a further aspect of the invention, which is claimed in claim 5, the first sub-network and the second sub-network reside on different chips, the data processing system being provided with a further conversion unit, wherein an off-chip link is provided between the conversion unit and the further conversion unit. The conversion means is extended with a further conversion unit which cooperates with the first conversion unit. This is advantageous when an off-chip link is provided between the conversion units.

In a further aspect of the invention, which is claimed in claim 6, the first sub-network and the second sub-network reside on a single chip, the first sub-network and the second sub-network having different clock domains, characterized in that the conversion unit is also arranged to provide clock-domain crossing. In this embodiment the conversion unit is integrated with means to perform the clock-domain crossing.

The present invention is described in more detail with reference to the drawings, in which:

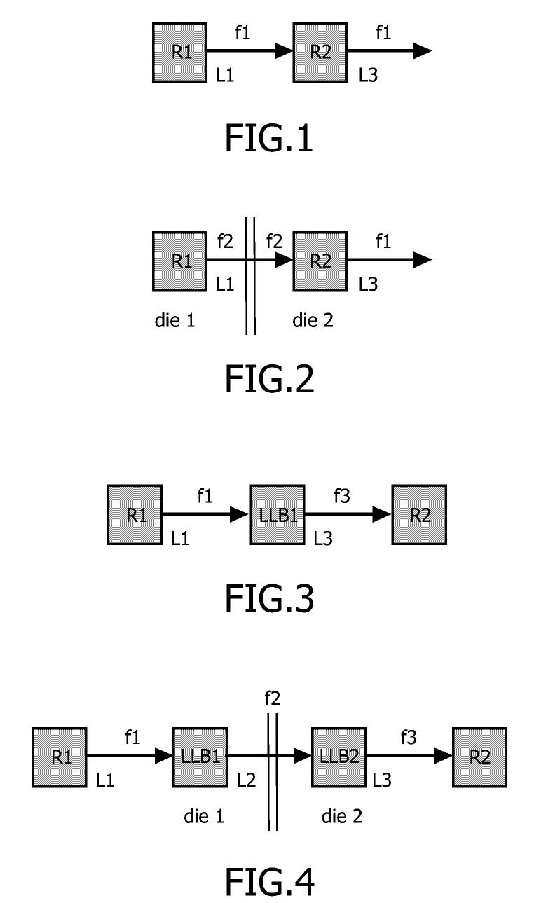

FIG. 1 illustrates a known configuration of communicating routers in a network on an integrated circuit;

FIG. 2 illustrates a known configuration of communicating routers which reside on different dies;

FIG. 3 illustrates an example of a link-level bridge according to the invention;

FIG. 4 illustrates an example of a further link-level bridge according to the invention;

FIG. 5 illustrates a known concept of credit-based link-level flow control;

FIG. 6 illustrates an example of a bridge buffer unit comprised in a link-level bridge according to the invention;

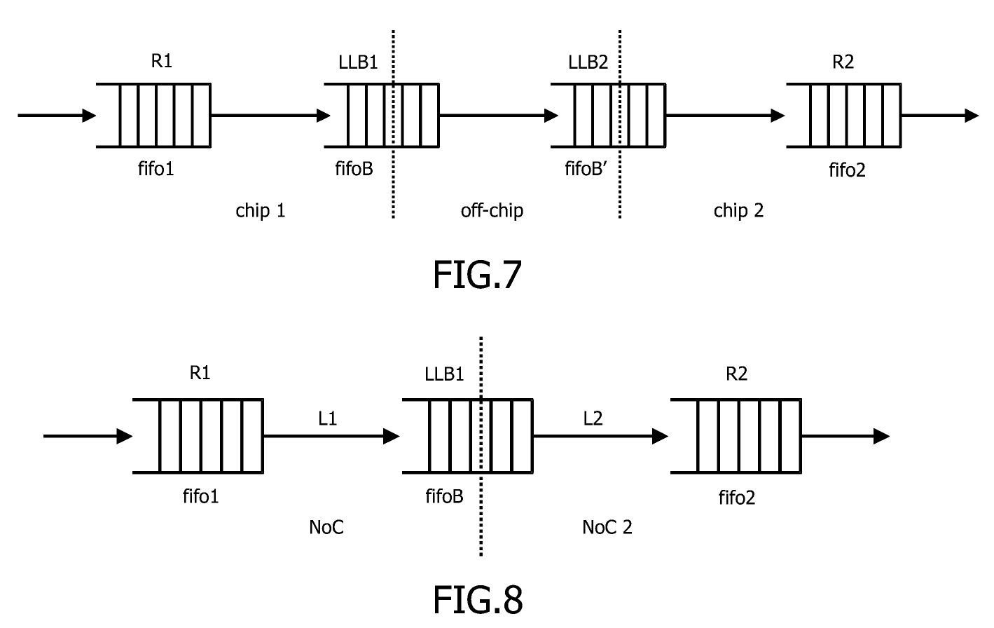

FIG. 7 illustrates an application of a link-level bridge and a further link-level bridge according to the invention;

FIG. 8 illustrates an application of a link-level bridge according to the invention;

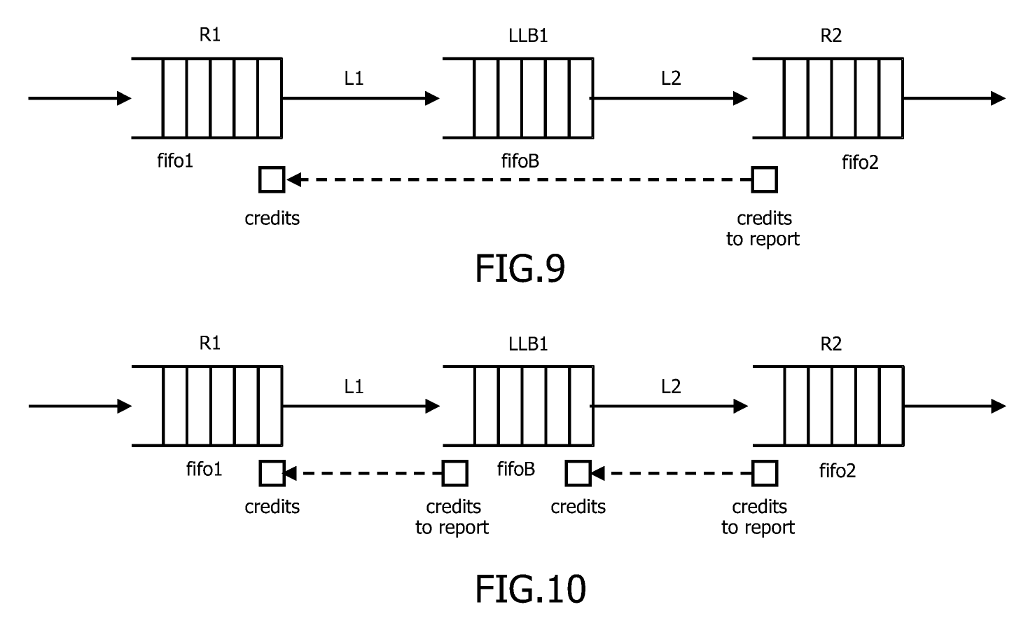

FIG. 9 illustrates a use of credit-based link-level flow control scheme which leads to a buffer overflow;

FIG. 10 illustrates a use of a flow control scheme in a conversion unit in a link-level bridge according to the invention;

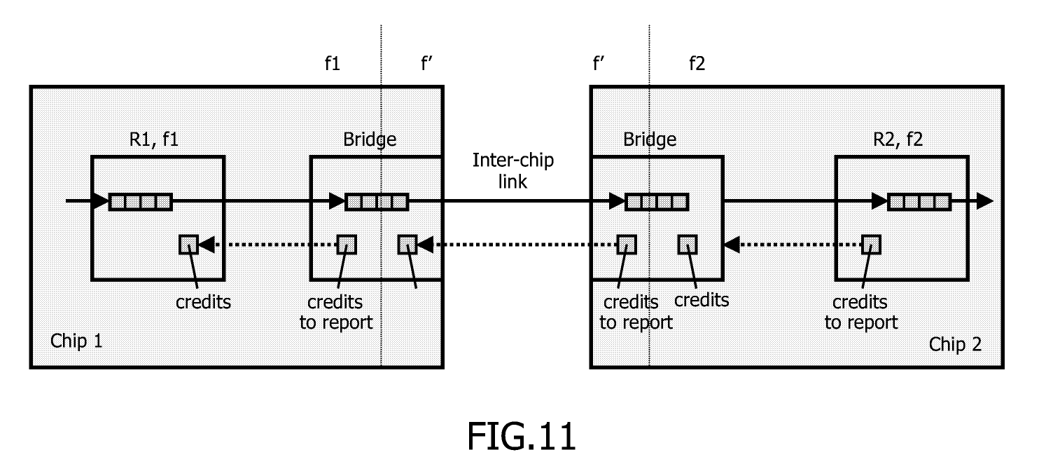

FIG. 11 illustrates an example of an application of two link-level bridges according to the invention;

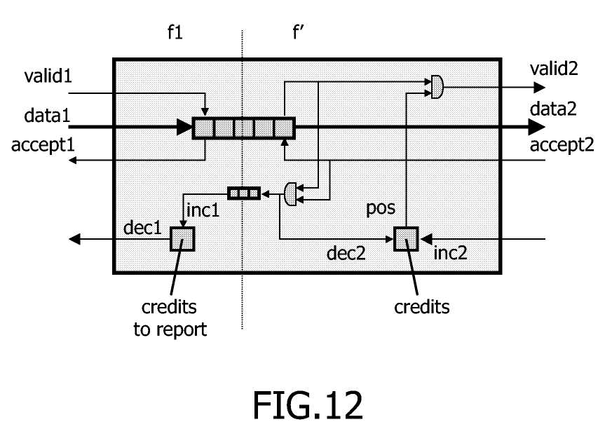

FIG. 12 illustrates an example of an architecture of a link-level bridge according to the invention.

FIG. 1 illustrates a known configuration of communicating routers R1, R2 in a network on an integrated circuit. The network comprises a collection of routers R1, R2 which are connected via links L1, L3. Both links operate at a certain clock or operating frequency f1. Both routers R1, R2 have the same view on the link L1 between the routers in terms of performance (clock frequency, phase, bit width etc.) This is the currently prevailing Network-on-Chip view.

FIG. 2 illustrates a known configuration of communicating routers R1, R2 which reside on different dies die 1, die 2. The network may be extended to cover multiple dies, which concept is referred to as multi-chip or multi-die networks. The routers R1, R2 are part of different sub-networks; in this case sub-networks which reside on different dies. The routers R1, R2 still wish to have the same view on the link L1 in terms of performance, but the performance of link L1 may be different from the performance of other links (e.g. link L3) in the sub-networks of routers R1 and R2. In this case, links L1 and L3 have different clock or operating frequencies, respectively f2 and f1. The links L1 and L3 may be given an equal performance, but this underutilizes either the links within the sub-networks (such as L3) or the link between the sub-networks (L1). Another possibility would be to make the routers R1, R2 aware that link L1 is different from link L3, but this requires modification and complication of the routers, which is undesirable in view of the cost and reusability of the routers. So, a better solution would be to hide the deviant behavior of the link L1 from the routers R1 and R2. This can be achieved by deploying a conversion unit according to the invention. The conversion unit may be embodied as a link-level bridge, because it can perform conversion on the so-called ‘link-level’ in the OSI model.

FIG. 3 illustrates an example of a link-level bridge LLB1 according to the invention. The routers R1, R2 remain unchanged and the link-level bridge LLB1 is reusable within and across networks. An important function of the link-level bridge LLB1 is to hide from a router that the link it uses to communicate with another router or a network interface has different characteristics than it expects. Examples of differences that can be hidden from a router are differences of physical and link-layer (in the OSI model) characteristics, such as:

medium (on-chip copper versus off-chip fiber, etc.);

clock or operating frequency (i.e. speed);

clock phases;

link width;

link-level flow control schemes;

operating modes (e.g. burst mode versus constant transmission mode).

The link-level bridge LLB1 is arranged to translate between physical and link-level protocols, from link L1 to link L3. Communication between router R1 and router R2 takes place in the form of packets. Typically, packets comprise at least one of a header, a payload and a tail. The packets are further split and allocated to so-called flow control units. A flow control unit is commonly referred to as a ‘flit’.

FIG. 4 illustrates an example of a further link-level bridge LLB2 according to the invention. This configuration is particularly suitable for sub-networks residing on different dies, wherein a first link-level bridge LLB1 collaborates with a second link-level bridge LLB2 to provide the said conversion between the routers R1, R2 comprised in the respective sub-networks. The link L2 between the first link-level bridge LLB1 and the second link-level bridge LLB2 would typically be an off-chip link. In this case, the conversion takes a step-wise approach: first a conversion from the on-chip link L1 to the off-chip link L2 is performed, and subsequently a conversion from the off-chip link L2 to the on-chip link L3 is performed, and vice versa. The link-level flow control between the first router R1 and the second router R2 is thereby decomposed into three stages: (1) flow control on the link L1, (2) flow control on the link L2, and (3) flow control on the link L3. The implementation of link-level flow control in two or more stages (by means of at least one link-level bridge LLB1) will be discussed in more detail with reference to FIG. 10.

First, the principle of link-level flow control will be discussed. FIG. 5 illustrates a known concept of credit-based link-level flow control. Two routers R1, R2 are comprised in a single sub-network. The routers R1, R2 are connected via a direct link L. Data elements which take the form of flits are transmitted via link L from the first router R1 to the second router R2. The routers R1, R2 comprise buffer units fifo1, fifo2 which are arranged to store data elements temporarily, e.g. if they cannot be transmitted yet. It is assumed that a single location in the buffer units fifo1, fifo2 accommodates one flit. Alternatively another mapping may be used, such as one buffer location accommodating one word. The first router R1 comprises a credits (remote space) counter whose value represents the available locations in the buffer unit fifo2 of the second router R2, i.e. the number of flits that may successfully be transmitted and stored in the second router R2.

Initially, if the buffer unit fifo2 of the second router R2 is still empty, the value of the credits (remote space) counter is equal to the size of this buffer unit. Router R1 can send as much flits as it has credits, i.e. a number of flits which is equal to the value of the credits (remote space) counter. When the first router R1 transmits data to the second router R2, it decrements the credits (remote space) counter by the amount of flits which it transmits. When data leaves the buffer unit fifo2 of the second router R2, the value of the credits to report counter is incremented by the number of flits which have left this buffer unit. If the value of the credits to report counter is larger than zero, this value is reported to the first router R1, where it is added to the value of the credits (remote space) counter. In this manner, no data will be sent to the second router R2 if there is no buffer space for storing the data, and therefore no data will be lost (i.e. the communication is lossless).

FIG. 6 illustrates an example of a bridge buffer unit fifoB comprised in a link-level bridge LLB1 according to the invention. The first router R1 (also referred to as a producing router) residing in a first sub-network domain 1 transmits data to the second router R2 (also referred to as a consuming router) residing in a second sub-network domain 2 through the link-level bridge LLB1. The link-level bridge LLB1 comprises the bridge buffer unit fifoB which is arranged to store data received from the first router R1 via link L1. This storing of data is needed to compensate for differences in operating frequency, for example.

It is noted that the link-level bridge LLB1 may contain more than one buffer unit, for example a series of first-in first-out buffer units. The use of a single bridge buffer unit fifoB can be seen as an abstraction. A person skilled in the art can select the actual implementation and location of the buffer. Examples of buffer implementations are a double latch for frequency conversion and a sequentializer for link width conversion.

FIG. 7 illustrates an application of a link-level bridge LLB1 and a further link-level bridge LLB2 according to the invention. In this example, the first router R1 and the link-level bridge LLB1 reside on a first integrated circuit chip 1. The second router R2 and the further link-level bridge LLB2 reside on a second integrated circuit chip 2. The off-chip link between the first integrated circuit chip 1 and the second integrated circuit chip 2 typically has characteristics which are very different from the characteristics of the on-chip links. Both link-level bridges LLB1, LLB2 have bridge buffer units fifoB, fifoB′ which are deployed for the flow control scheme conversion from the first integrated circuit chip 1 to the second integrated circuit chip 2.

FIG. 8 illustrates an application of a link-level bridge LLB1 according to the invention. In this example, the first router R1 is comprised in a first sub-network NoC and the second router R2 is comprised in a second sub-network NoC 2. The first sub-network NoC and the second sub-network NoC 2 have different operating conditions. The link-level bridge LLB1 converts the flow control scheme deployed in the first sub-network NoC into the flow control scheme deployed in the second sub-network NoC 2. It is noted that the link-level bridge LLB1 conceptually forms part of both sub-networks, or resides between the sub-networks, depending on the interpretation of the concept. Physically the link-level bridge LLB1 may be, for example, an adapted network interface component residing within one of the sub-networks, a combination of two link-level bridge components similar to the configuration illustrated in FIG. 7, or another implementation to be selected by the skilled person.

FIG. 9 illustrates a use of credit-based link-level flow control scheme which could lead to a buffer overflow. If the credit-based link-level flow control mechanism would not be adapted to take into account the presence of the link-level bridge LLB1, then the credits in the credits counter of router R1 would not reflect the empty space in the bridge buffer unit fifoB, but the empty space in the buffer unit fifo2 of router R2. If the bridge buffer unit fifoB is slower and smaller than the buffer unit fifo2, then the bridge buffer unit fifoB can fill up even if the number of credits is larger than zero. As a result there will be a buffer overflow in the link-level bridge LLB1, which causes a loss of data.

FIG. 10 illustrates a use of a flow control scheme in a conversion unit according to the invention. In this example, each pair of buffer units (respectively fifo1-fifoB and fifoB-fifo2) has a separate flow control mechanism, which avoids the overflow of the bridge buffer unit fifoB. It is noted that the buffers fifo1, fifoB and fifo2 can have different sizes. It is assumed that credits are associated with flits, i.e. one credit represents one flit, although other mappings are possible. In most networks-on-chip a flit is the smallest amount of data which can be dealt with. One flit may consist of a number of words, for example. The flit size is variable which means that different (sub-)networks may deploy different flit sizes, but within a (sub-)network the flit size is fixed.

As mentioned before, because the flow control mechanism has been divided into separate flow control mechanisms for the pairs of buffers fifo1-fifoB and fifoB-fifo2, the buffer overflow in the link-level bridge LLB1 can be avoided. However, if the flit sizes are different in the sub-networks, then additionally credit conversion is required. For example, if the flit size in the sub-network of router R1 is 2 words and the flit size in the sub-network of router R2 is 4 words, then three 4-word flits which leave the link-level bridge LLB1 must be translated into six credits to report to router R1. Or, if the flit size in the sub-network of router R1 is 3 words and the flit size in the sub-network of router R2 is 4 words, then three 4-word flits which leave the link-level bridge LLB1 must be translated into four credits to report to router R1.

FIG. 11 illustrates an example of an application of two link-level bridges according to the invention. Two integrated circuits Chip 1, Chip 2 comprise networks running at different operating frequencies f1, f2. The two integrated circuits are connected via an external serial link Inter-chip link. Two link-level bridges are used to implement the conversion of flow control schemes. The external link is transparent to the two networks.

FIG. 12 illustrates an example of an architecture of a link-level bridge according to the invention. The bridge can send data via data2 only if the value of ‘credits’ is positive, such that ‘pos’ has a logic high value. When the receiver of the data sent by the bridge signals back via ‘inc2’, the ‘credits’ counter is incremented. When ‘data2’ is sent further (‘valid2’ and ‘accept2’ both have a logic high value), the credits associated to that queue (‘credits’) are decremented. A credit is produced, which crosses the clock domain boundary via a fifo buffer unit and causes the ‘credits to report’ counter to be incremented. The ‘credits to report’ are reported back via dec1 to the router/NI sending data to the bridge.

It is remarked that the scope of protection of the invention is not restricted to the embodiments described herein. Neither is the scope of protection of the invention restricted by the reference symbols in the claims. The word ‘comprising’ does not exclude other parts than those mentioned in a claim. The word ‘a(n)’ preceding an element does not exclude a plurality of those elements. Means forming part of the invention may both be implemented in the form of dedicated hardware or in the form of a programmed general-purpose processor. The invention resides in each new feature or combination of features.

1. A data processing system on at least one integrated circuit, the data processing system comprising at least two modules and a network arranged to transmit data between the modules, the data processing system being arranged to apply a flow control scheme for synchronizing data traffic between the modules, wherein the network comprises a first sub-network (NoC) and a second sub-network (NoC 2), the first sub-network (NoC) and the second sub-network (NoC 2) having different operating conditions, characterized in that the data processing system further comprises a conversion unit (LLB1), the conversion unit being arranged to convert a first flow control scheme applied in the first sub-network (NoC) into a second flow control scheme applied in the second sub-network (NoC 2).

2. A data processing system as claimed in claim 1, wherein the flow control scheme for synchronizing data traffic between the modules is based on credits stored in a first module, which credits represent the amount of data which can be received by a second module.

3. A data processing system as claimed in claim 1, wherein the first sub-network (NoC) comprises a first router (R1) and the second sub-network (NoC 2) comprises a second router (R2), an output of the first router (R1) being coupled to an input of the conversion unit (LLB1), and an output of the conversion unit (LLB1) being coupled to an input of the second router (R2), wherein the first router (R1) comprises a first buffer unit (fifo1), and wherein the second router (R2) comprises a second buffer unit (fifo2), wherein the conversion unit (LLB1) is arranged to receive data from the first buffer unit (fifo1), and wherein the conversion unit (LLB1) is further arranged to store data for transmission to the second buffer unit (fifo2), the conversion unit (LLB1) comprising an intermediate buffer unit (fifoB) for storing the data, characterized in that the communication between the first buffer unit (fifo1) and the intermediate buffer unit (fifoB) is controlled by the first flow control scheme, and in that the communication between the intermediate buffer unit (fifoB) and the second buffer unit (fifo2) is controlled by the second flow control scheme.

4. A data processing system as claimed in claim 3, wherein the first sub-network (NoC) and the second sub-network (NoC 2) use flow control units (flits) having different sizes, and wherein the conversion unit (LLB1) is arranged to convert credits used by the second flow control scheme into credits used by the first flow control scheme.

5. A data processing system as claimed in claim 1, wherein the first sub-network (NoC) and the second sub-network (NoC 2) reside on different chips (chip 1, chip 2), the data processing system being provided with a further conversion unit (LLB2), wherein an off-chip link is provided between the conversion unit (LLB1) and the further conversion unit (LLB2).

6. A data processing system as claimed in claim 1, wherein the first sub-network (NoC) and the second sub-network (NoC 2) reside on a single chip, the first sub-network (NoC) and the second sub-network (NoC 2) having different clock domains, characterized in that the conversion unit (LLB1) is also arranged to provide clock-domain crossing.

7. A method for synchronizing data traffic in a data processing system on at least one integrated circuit, the data processing system comprising at least two modules and a network which transmits data between the modules, wherein the data processing system applies a flow control scheme for synchronizing data traffic between the modules, wherein the network comprises a first sub-network (NoC) and a second sub-network (NoC 2), the first sub-network (NoC) and the second sub-network (NoC 2) having different operating conditions, characterized in that the data processing system further comprises a conversion unit (LLB1), the conversion unit converting a first flow control scheme applied in the first sub-network (NoC) into a second flow control scheme applied in the second sub-network (NoC 2).
